(19) United States
(12) Patent Application Publication
(10) Pub. No.: US 2024/0092963 A1
(43) Pub. Date: Mar. 21, 2024

(54) RESIN COMPOSITION AND ADHESIVE

(71) Applicant: AAC Technologies (Nanjing) Co., Ltd., Nanjing (CN)

(72) Inventors: Hongyuan Wang, Shenzhen (CN); Yilan Zhang, Shenzhen (CN); Rui Pan, Shenzhen (CN); Hezhi Wang, Shenzhen (CN)

(21) Appl. No.: 18/091,307

(22) Filed: Dec. 29, 2022

Related U.S. Application Data
(63) Continuation of application No. PCT/CN2022/121745, filed on Sep. 27, 2022.

(30) Foreign Application Priority Data
Sep. 5, 2022 (CN) 202211080228.7

(51) Int. Cl. C08G 14/06; B32B 7/12; B32B 15/01; B32B 15/20; C08G 59/24; C08G 59/28; C08G 73/10; C08G 73/12

(52) U.S. Cl. CPC C08G 14/06; B32B 7/12; B32B 15/01; B32B 15/20; C08G 59/245; C08G 59/28; C08G 73/1021; C08G 73/12; B32B 2311/12; B32B 2457/08

(57) ABSTRACT

This application provides a resin composition and an adhesive. The resin composition is composed of benzoxazine and a resin. The benzoxazine is synthesized from a primary amine-capped flexible polyimide oligomer, an aldehyde and a monofunctional phenolic compound. The resin contains one or more of an epoxy resin, a maleimide resin, and a cyanate ester resin containing two or more functional groups. The resin is 0.1%-70% by weight of the benzoxazine.

### TECHNICAL FIELD

The present application relates to electronic adhesives, and more particularly to a resin composition and an adhesive.

### BACKGROUND

With the development of information technology, the electronic transmission has been developed in the tendency of high frequency and high speed, and a multi-functional, multi-density and multi-level electronic product is appreciated in the future. Flexible printed circuit boards have been increasingly used in electronic devices, and the challenge posed to their performance is growing.

How to reduce the loss under high-frequency transmission and maintain good stability even at higher temperature has been a great challenge in recent years. In this regard, the adhesive material, as an important part of the flexible copper clad laminate, needed to be further optimized in performance.

With regard to the adhesive material, the resin composition is the most important part. However, the adhesive material composed of the existing resin composition can no longer the requirements of novel flexible copper clad laminates for bonding, sealing and potting performances.

### SUMMARY

An object of the present application is to provide a resin composition to solve the problem that the adhesive materials composed of the existing benzoxazine resins can no longer meet the needs of new flexible copper clad laminates.

In a first aspect, this application provides a resin composition, comprising:
benzoxazine; and
a resin;
wherein the benzoxazine is synthesized from a primary amine-capped flexible polyimide oligomer, an aldehyde and a monofunctional phenolic compound; and
the resin comprises one or more of an epoxy resin, a maleimide resin, and a cyanate ester resin containing two or more functional groups; and the resin is 0.1%-70% by weight of the benzoxazine.

In an embodiment, a molecular formula of the benzoxazine is shown as follows:

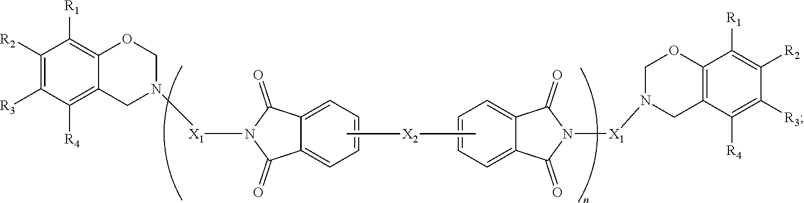

wherein R₁, R₂, R₃ and R₄ are each independently selected from the group consisting of —H, alkyl, alkoxy, cycloalkyl, and aryl, and at least one of R₁, R₂, R₃ and R₄ is —H; X₁ is an alkyl and/or alkoxy containing a long chain structure in main chain or side chain; and X₂ is one or more selected from alkyl, ether group, alkoxy, alkyl ester group, carbonyl, sulfone group, and thioether group.

In an embodiment, X₁ is an alkyl or alkoxy containing 5-30 carbon atoms.

In an embodiment, the primary amine-capped flexible polyimide oligomer has a number-average molecular weight of 1,000-50,000.

In an embodiment, the primary amine-capped flexible polyimide oligomer is a reaction product of a tetracarboxylic acid dianhydride and a flexible diamine; and a molar ratio of dianhydride in the tetracarboxylic acid dianhydride to the flexible diamine is 1:(1.01-1.1).

In an embodiment, the tetracarboxylic acid dianhydride is selected from the group consisting of 3,3′,4,4′-biphenyltetracarboxylic dianhydride, 4,4′-oxydiphthalic anhydride, 3,3′,4,4′-benzophenonetetracarboxylic dianhydride, 4,4′-(hexafluoroisopropylidene)diphthalic anhydride, 4,4′-(4,4′-isopropylidenediphenoxy)bis(phthalic anhydride) and a combination thereof.

In an embodiment, the flexible diamine is a mixture of a diamine containing a flexible long chain in main chain or side chain and an aromatic diamine; and a molar ratio of the diamine containing a flexible long chain in main chain or side chain to the aromatic diamine is (1:9)-(10:0).

In an embodiment, a molecular formula of the diamine containing a flexible long chain in main chain or side chain is shown as follows:

H₂N—X₃—NH₂;
wherein X₃ is an alkyl or/and alkoxy containing a long chain structure in main chain or side chain; and
the aromatic diamine is selected from the group consisting of m-phenylenediamine, 4,4′-diaminodiphenyl ether, p-phenylenediamine, 1,3-bis(3-aminophenoxy)benzene, 1,3-bis(4-aminophenoxy)benzene, and 1,4-bis(4-aminophenoxy)benzene.

In an embodiment, X₃ is an alkyl or alkoxy containing 5-30 carbon atoms.

In an embodiment, the primary amine-capped flexible polyimide oligomer is prepared through steps of:
(S1) dissolving the flexible diamine in a solvent under the protection of nitrogen to obtain a first mixture;
(S2) stepwise adding the tetracarboxylic acid dianhydride to the first mixture; performing reaction at a first preset temperature for a first preset time to obtain a second mixture; and
(S3) adding a catalyst or a water-carrying agent to the second mixture followed by reaction at a second preset temperature for a second preset time and precipitation or drying to obtain the primary amine-capped flexible polyimide oligomer.

In an embodiment, the aldehyde is formaldehyde, paraformaldehyde or a mixture thereof.

In an embodiment, the monofunctional phenolic compound is selected from the group consisting of phenol, methyl phenol, and ethyl phenol.

In an embodiment, the epoxy resin is selected from the group consisting of phenolic epoxy resin, bisphenol A epoxy resin, bisphenol F epoxy resin, bisphenol S epoxy resin, alicyclic epoxy resin, silane modified epoxy resin, vinyl dioxide epoxy resin, epoxidized polybutadiene epoxy resin, trifunctional epoxy resin, and tetraglycidyl epoxy resin.

In an embodiment, the maleimide resin is selected from the group consisting of m-phenylene bismaleimide resin, 4,4-diphenylmethane bismaleimide resin, 4,4-diphenyl ether bismaleimide resin and N,N′-m-phenylene bismaleimide resin.

In an embodiment, the cyanate ester resin is selected from the group consisting of bisphenol A cyanate ester resin, bisphenol E cyanate ester resin, bisphenol F cyanate ester resin, bisphenol M cyanate ester resin, tetramethyl bisphenol A cyanate ester resin and dicyclopentadienyl cyanate ester resin.

In a second aspect, this application provides an adhesive, comprising:
the above-mentioned resin composition;
a curing accelerator; and
an organic solvent.

In an embodiment, the curing accelerator is selected from the group consisting of imidazole, 1-methylimidazole, 1,2-dimethylimidazole, formic acid, acetic acid, propionic acid, aniline, benzylamine, azobisisobutyronitrile, azobisisoheptonitrile, benzoyl peroxide, methyl ethyl ketone peroxide, tert-butyl peroxide and a combination thereof.

In an embodiment, the organic solvent is selected from the group consisting of toluene, xylene, dioxane, tetrahydrofuran, methanol, ethanol, acetone, butanone, cyclohexanone, N,N-dimethylformamide, N,N-dimethylacetamide, N-methylpyrrolidone and a combination thereof.

In an embodiment, the adhesive is applied to film adhesive materials, adhesive layers, adhesive sheets, resin-coated copper foils, copper-clad laminates and multi-layer resin substrates.

Compared to the prior art, the resin composition of this application is obtained by mixing benzoxazine with a resin, such that characteristics of the benzoxazine and resin are combined, making the adhesive containing the same satisfy the requirements of novel flexible copper clad laminates.

### DETAILED DESCRIPTION OF THE EMBODIMENTS

The present application will be further described below with reference to the accompanying drawings and embodiments to make objects, technical solutions, and advantages of the present application clearer. It should be understood that these embodiments are merely illustrative of the present application, and are not intended to limit the present application.

### EXAMPLE 1

This example provides a resin composition composed of benzoxazine and a resin, where the benzoxazine is synthesized from a primary amine-capped flexible polyimide oligomer, an aldehyde and a monofunctional phenolic compound, and the resin comprises one or more of an epoxy resin, a maleimide resin, and a cyanate ester resin containing two or more functional groups.

Specifically, the resin is 0.1%-70%, preferably 0.5%-50%, by weight of the benzoxazine.

In this example, a molecular formula of the benzoxazine is shown as follows:

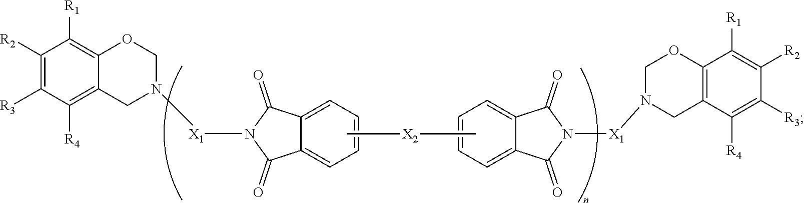

where R₁, R₂, R₃ and R₄ are each independently selected from the group consisting of —H, alkyl, alkoxy, cycloalkyl, and aryl, and at least one of R₁, R₂, R₃ and R₄ is —H; X₁ is an alkyl or/and alkoxy containing a long chain structure in main chain or side chain; X₂ is one or more selected from alkyl, ether group, alkoxy, alkyl ester group, carbonyl, sulfone group, and thioether group; and n is 1-150.

Specifically, X₁ is an alkyl or alkoxy containing 5-30 carbon atoms

In this example, the primary amine-capped flexible polyimide oligomer has a number-average molecular weight of 1,000-50,000 g/mol.

In this example, the primary amine-capped flexible polyimide oligomer is a reaction product of a tetracarboxylic acid dianhydride and a flexible diamine; and a molar ratio of dianhydride in the tetracarboxylic acid dianhydride to the flexible diamine is 1:(1.01-1.1).

The tetracarboxylic acid dianhydride is selected from the group consisting of 3,3′,4,4′-biphenyltetracarboxylic dianhydride, 4,4′-oxydiphthalic anhydride, 3,3′,4,4′-benzophenonetetracarboxylic dianhydride, 4,4′-(hexafluoroisopropylidene)diphthalic anhydride, 4,4′-(4,4′-isopropylidenediphenoxy)bis(phthalic anhydride) and a combination thereof.

The flexible diamine is a mixture of a diamine containing a flexible long chain in main chain or side chain and an aromatic diamine; and a molar ratio of the diamine containing a flexible long chain in main chain or side chain to the aromatic diamine is (1:9)-(10:0).

Specifically, the molar ratio of the diamine containing a flexible long chain in main chain or side chain to the aromatic diamine is (2:8)-(10:0).

The diamine containing a flexible long chain in main chain or side chain is represented by the following formula:

H₂N—X₃—NH₂;
where X₃ is an alkyl or/and alkoxy containing a long chain structure in main chain or side chain.

Specifically, X₃ is an alkyl or alkoxy containing 5-30 carbon atoms.

The aromatic diamine is selected from the group consisting of m-phenylenediamine, 4,4′-diaminodiphenyl ether, p-phenylenediamine, 1,3-bis(3-aminophenoxy)benzene, 1,3-bis(4-aminophenoxy)benzene, and 1,4-bis(4-aminophenoxy)benzene.

In this example, the primary amine-capped flexible polyimide oligomer is prepared through steps of:
(S1) dissolving the flexible diamine in a solvent under the protection of nitrogen to obtain a first mixture;
(S2) stepwise adding the tetracarboxylic acid dianhydride to the first mixture; and performing reaction at a first preset temperature for a first preset time to obtain a second mixture, where the first preset temperature and the first preset time are set according to the selected compounds and are not specifically limited herein, and as actually needed, the first preset temperature can be −20-30° C. and the first preset time can be 0.5-24 h; and
(S3) adding a catalyst or a water-carrying agent to the second mixture followed by reaction at a second preset temperature for a second preset time and precipitation or drying to obtain the primary amine-capped flexible polyimide oligomer, where the second preset temperature and the second preset time are set according to the selected compounds and are not specifically limited herein.

In this example, the benzoxazine is prepared through steps of:
dissolving the primary amine-capped flexible polyimide oligomer, the aldehyde and the monofunctional phenolic compound in a solvent followed by reaction at a third preset temperature for a third preset time to obtain the benzoxazine.

The third preset temperature and the third preset time are set according to the selected compounds and are not specifically limited herein, and as actually needed, the third preset temperature can be 60-180° C. and the third preset time can be 0.5-10 h.

In this example, the aldehyde formaldehyde, paraformaldehyde or a mixture thereof; and the monofunctional phenolic compound is selected from the group consisting of phenol, methyl phenol, and ethyl phenol.

In this example, the epoxy resin is selected from the group consisting of phenolic epoxy resin, bisphenol A epoxy resin, bisphenol F epoxy resin, bisphenol S epoxy resin, alicyclic epoxy resin, silane modified epoxy resin, vinyl dioxide epoxy resin, epoxidized polybutadiene epoxy resin, trifunctional epoxy resin, and tetraglycidyl epoxy resin.

In this example, the maleimide resin is selected from the group consisting of m-phenylene bismaleimide resin, 4,4-diphenylmethane bismaleimide resin, 4,4-diphenyl ether bismaleimide resin and N,N′-m-phenylene bismaleimide resin.

In this example, the cyanate ester resin is selected from the group consisting of bisphenol A cyanate ester resin, bisphenol E cyanate ester resin, bisphenol F cyanate ester resin, bisphenol M cyanate ester resin, tetramethyl bisphenol A cyanate ester resin and dicyclopentadienyl cyanate ester resin.

Compared to the prior art, the resin composition of this application is obtained by mixing benzoxazine with a resin, such that characteristics of the benzoxazine and resin are combined, making the adhesive containing the same satisfy the requirements of novel flexible copper clad laminates.

### EXAMPLE 2

This example provides an adhesive, which contains the resin composition of Example 1, a curing accelerator and an organic solvent.

In this example, the curing accelerator is selected from the group consisting of imidazole, 1-methylimidazole, 1,2-dimethylimidazole, formic acid, acetic acid, propionic acid, aniline, benzylamine, azobisisobutyronitrile, azobisisoheptonitrile, benzoyl peroxide, methyl ethyl ketone peroxide, tert-butyl peroxide and a combination thereof.

In this example, the organic solvent is selected from the group consisting of toluene, xylene, dioxane, tetrahydrofuran, methanol, ethanol, acetone, butanone, cyclohexanone, N,N-dimethylformamide, N,N-dimethylacetamide, N-methylpyrrolidone and a combination thereof.

In this example, the adhesive is applied to film adhesive materials, adhesive layers, adhesive sheets, resin-coated copper foils, copper-clad laminates and multi-layer resin substrates.

Since the adhesive provided herein contains the resin composition of Example 1, it can meet the performance requirements of the novel flexible copper clad laminates when applied thereto.

### EXAMPLE 3

Provided herein was a method for preparing benzoxazine. Specifically, under the protection of nitrogen (N₂), 21 g of polyetheramine D400 was evenly mixed with 110.03 g of N-methylpyrrolidone (NMP) in a single-necked flask equipped with a magnetic stirrer and a water separation device, to which 26.16 g of 4,4′-(4,4′-isopropylidenediphenoxy)bis(phthalic anhydride) (BPADA, manufactured by CHINATECH (Tianjin) Chemical Co., Ltd.) was slowly added. The reaction mixture was reacted at room temperature for 1 h, and then reacted at 140° C. for 10 h to obtain a primary amine-capped flexible polyimide oligomer solution. After cooled, the single-necked flask was added with 0.24 g of phenol, 0.15 g of paraformaldehyde and 0.90 g of toluene, and the water separation device was replaced with a condenser. The reaction mixture was heated to 90° C. and refluxed for 6 h. After the reaction was completed, a yellow transparent liquid with 30% solid content was collected as the benzoxazine.

### EXAMPLE 4

Provided herein was a resin composition, which was prepared as follows. 10 g of the benzoxazine prepared in Example 3 was mixed with 0.15 g of an epoxy resin (Shell-EPON1031) in NMP to obtain the resin composition with 30 wt. % solid content.

### EXAMPLE 5

Provided herein was a resin composition, which was prepared as follows. 10 g of the benzoxazine prepared in Example 3 was mixed with 0.15 g of bismaleimide (BMI-01, Honghu City Shuangma New Material Tech Co., Ltd.) in NMP to obtain the resin composition with 30 wt. % solid content.

### EXAMPLE 6

Provided herein was a resin composition, which was prepared as follows. 10 g of the benzoxazine prepared in Example 3 was mixed with 0.15 g of a cyanate ester (C01PO, Yangzhou Tianqi New Material Co., Ltd.) in NMP to obtain the resin composition with 30 wt. % solid content.

### EXAMPLE 7

Provided herein was a resin composition, which was prepared as follows. 10 g of the benzoxazine prepared in Example 3 was mixed with 0.3 g of a trifunctional epoxy resin (AFG-90, Shanghai Huayi Resin Co., Ltd.) in NMP to obtain the resin composition with 30 wt. % solid content.

### Comparative Example 1

Provided herein was a method for preparing a flexible polyimide solution. Specifically, under the protection of nitrogen, 8 g of polyetheramine D400 was dissolved with 43.08 g of N-methylpyrrolidone (NMP) in a single-necked flask equipped with a magnetic stirrer and a water separation device, to which 10.46 g of 4,4′-(4,4′-isopropylidenediphenoxy)bis(phthalic anhydride) (BPADA, manufactured by CHINATECH (Tianjin) Chemical Co., Ltd.) was slowly added. The reaction mixture was reacted at room temperature for 1 h, and then reacted at 140° C. for 10 h to obtain the flexible polyimide solution.

### Comparative Example 2

Provided herein was the benzoxazine prepared in Example 3.

The composition of Examples 4-7 and Comparative Examples 1-2 was shown in Table 1.

TABLE 1
Composition of Examples 4-7 and Comparative Examples 1-2

| | Example | | | | | |
|---|---|---|---|---|---|---|
| | | | | | Comparative | Comparative |
| Ingredient | Example 4 | Example 5 | Example 6 | Example 7 | Example 1 | Example 2 |
| Benzoxazine | 10 g | 10 g | 10 g | 10 g | / | 10 g |
| EPON1031 | 0.15 g | / | / | / | / | |
| AFG-90 | | | | 0.15 g | | |
| Bismaleimide | / | 0.15 g | / | / | / | |
| Cyanate ester | / | / | 0.15 g | / | / | |
| Polyimide | / | / | / | / | 10 g | |

### EXAMPLE 8

Provided herein was a method for fabricating an adhesive sheet. Specifically, compositions prepared in Examples 4-7 and Comparative Examples 1-2 (having a thickness of 12.5 μm after dried) were respectively spread onto a polyimide film, and dried at 220° C. for 3 min to obtain the adhesive sheet.

### EXAMPLE 9

Provided herein was a method for fabricating a copper clad laminate. Specifically, adhesive sheets respectively prepared based on Examples 4-7 and Comparative Examples 1-2 were respectively overlaid on a rough surface of a copper foil, and processed at 160-300° C. and 2-10 MPa for 5-30 min to obtain the copper clad laminate.

The copper clad laminates fabricated based on Examples 4-7 were respectively named as Example 4-1, Example 5-1, Example 6-1, and Example 7-1, and the copper clad laminates fabricated based on Comparative Examples 1-2 were respectively named as Comparative Example 1-1 and Comparative Example 2-1.

Performance test results of Example 4-1, Example 5-1, Example 6-1, Example 7-1, Comparative Example 1-1 and Comparative Example 2-1 were shown in Table 2.

TABLE 2
Test results of Examples 4-1, 5-1, 6-1 and 7-1 and Comparative Examples 1-1 and 2-1

| | Example | | | | | |
|---|---|---|---|---|---|---|
| | | | | | Comparative | Comparative |
| Performance | Example 4-1 | Example 5-1 | Example 6-1 | Example 6-1 | Example 1-1 | Example 2-1 |
| Adhesion | 1.49 | 1.29 | 1.37 | 1.54 | 0.95 | 1.08 |
| property | | | | | | |
| (N/mm) | | | | | | |
| Soldering | OK | OK | OK | OK | NG | OK |
| resistance | | | | | | |
| Dk (10 GHz) | 2.92 | 2.79 | 2.85 | 3.12 | 2.81 | 2.89 |
| Df (10 GHz) | 0.0035 | 0.0029 | 0.0028 | 0.0036 | 0.0033 | 0.0031 |

The adhesion property was characterized by peel strength, and the peel strength was tested as follows. In accordance with the IPC-TM-650-2.4.8 test specifications, the sample was cut into 3.18 mm strips, and then the testing machine is started to apply a vertical tension at a speed of 50 mm/min until the peel length reached at least 25.4 mm. The test was performed four times, and the results were averaged. The testing machine was an electronic universal testing machine or other testing machines manufactured by Shenzhen Suns Technology Stock Co., Ltd.

Before the soldering resistance test, the single-side copper clad plate (copper clad laminate or sample) was cut into 50 mm×50 m strips according to IPC-TM-650-2.4.13 test specifications.

Dk was the dielectric constant and Df was the dielectric loss tangent. Before the test, the samples were respectively coated onto a fluorocarbon solid polytetrafluoroethylene (PTFE) (with a thickness of 50 μm after curing), cured at 220° C. and peeled to obtain a test sample with a thickness of about 50 μm for the dielectric property test.

The test sample was tested for the dielectric constant and dielectric loss tangent at 10 GHz by using a commercially available dielectric constant test device (cavity resonator type, made by AET) according to the IPC-TM-650-2.5.5.10 specifications.

By comparison, Examples 4-1, 5-1, 6-1 and 7-1 and Comparative Example 2-1 were superior to Comparative Example 1-1 in adhesion property and soldering resistance, indicating that the copper clad laminate fabricated based on the benzoxazine of Example 3 was superior to that fabricated in the prior art in the adhesion property and soldering resistance.

### EXAMPLE 10

Prepared herein was a method for fabricating a multi-layer resin substrate. Specifically, multiple adhesive sheets prepared respectively based on Examples 4-7 and Comparative Examples 1-2 were overlapped together and pressed at 160-300° C. and 2-10 MPa for 1-30 min to obtain the multi-layer resin substrate.

The multi-layer resin substrates fabricated based on Examples 4-7 were respectively named as Example 4-2, Example 5-2, Example 6-2, and Example 7-2, and the multi-layer resin substrates fabricated based on Comparative Examples 1-2 were respectively named as Comparative Example 1-2 and Comparative Example 2-2.

The adhesion property test results of Examples 4-2, 5-2, 6-2, and 7-2 and Comparative Examples 1-2 and 2-2 were shown in Table 3.

TABLE 3
Adhesion property test results of Examples 4-2, 5-2,
6-2, and 7-2 and Comparative Examples 1-2 and 2-2

| | Example | | | | | |
|---|---|---|---|---|---|---|
| | | | | | Comparative | Comparative |
| Performance | Example 4-2 | Example 5-2 | Example 6-2 | Example 7-2 | Example 1-2 | Example 2-2 |
| Adhesion | 1.32 | 1.09 | 1.25 | 1.46 | 0.57 | 0.98 |
| property | | | | | | |
| (N/mm) | | | | | | |

The adhesion property was characterized by peel strength, and the peel strength was tested as follows. In accordance with the IPC-TM-650-2.4.8 test specifications, the sample was cut into 3.18 mm strips, and then the testing machine is started to apply a vertical tension at a speed of 50 mm/min until the peel length reached at least 25.4 mm. The test was performed four times, and the results were averaged. The testing machine was an electronic universal testing machine or other testing machines manufactured by Shenzhen Suns Technology Stock Co., Ltd.

By comparison, Examples 4-2, 5-2, 6-2 and 7-2 and Comparative Example 2-2 were superior to Comparative Example 1-2 in adhesion property, indicating that the multi-layer resin substrate fabricated based on the benzoxazine of Example 3 was superior to that fabricated in the prior art in the adhesion property.

Described above are only preferred embodiments of the present application, which are not intended to limit the present application. It should be noted that any variations, replacements and modifications made by those of ordinary skill in the art without departing from the spirit and scope of the present application shall fall within the scope of the present application defined by the appended claims.

What is claimed is:

1. A resin composition, comprising:
benzoxazine; and
a resin;
wherein the benzoxazine is synthesized from a primary amine-capped flexible polyimide oligomer, an aldehyde and a monofunctional phenolic compound; and
the resin comprises one or more of an epoxy resin, a maleimide resin, and a cyanate ester resin containing two or more functional groups; and the resin mixture is 0.1%-70% by weight of the benzoxazine.

2. The resin composition of claim 1, wherein a molecular formula of the benzoxazine is shown as follows: 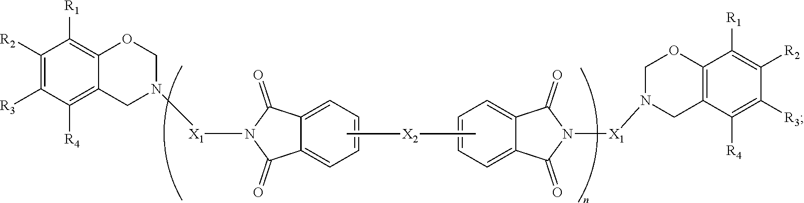
wherein R₁, R₂, R₃ and R₄ are each independently selected from the group consisting of —H, alkyl, alkoxy, cycloalkyl, and aryl, and at least one of R₁, R₂, R₃ and R₄ is —H; X₁ is an alkyl or/and alkoxy containing a long chain structure in main chain or side chain; and X₂ is one or more selected from alkyl, ether group, alkoxy, alkyl ester group, carbonyl, sulfone group, and thioether group.

3. The resin composition of claim 2, wherein X₁ is an alkyl or alkoxy containing 5-30 carbon atoms.

4. The resin composition of claim 1, wherein the primary amine-capped flexible polyimide oligomer has a number-average molecular weight of 1,000-50,000.

5. The resin composition of claim 1, wherein the primary amine-capped flexible polyimide oligomer is a reaction product of a tetracarboxylic acid dianhydride and a flexible diamine; and a molar ratio of dianhydride in the tetracarboxylic acid dianhydride to the flexible diamine is 1:(1.01-1.1)

6. The resin composition of claim 5, wherein the tetracarboxylic acid dianhydride is selected from the group consisting of 3,3′,4,4′-biphenyltetracarboxylic dianhydride, 4,4′-oxydiphthalic anhydride, 3,3′,4,4′-benzophenonetetracarboxylic dianhydride, 4,4′-(hexafluoroisopropylidene)diphthalic anhydride, 4,4′-(4,4′-isopropylidenediphenoxy)bis(phthalic anhydride) and a combination thereof.

7. The resin composition of claim 6, wherein the flexible diamine is a mixture of a diamine containing a flexible long chain in main chain or side chain and an aromatic diamine; and a molar ratio of the diamine containing a flexible long chain in main chain or side chain to the aromatic diamine is (1:9)-(10:0).

8. The resin composition of claim 7, wherein a molecular formula of the diamine containing a flexible long chain in main chain or side chain is shown as follows:
H₂N—X₃—NH₂;
wherein X₃ is an alkyl or/and alkoxy containing a long chain structure in main chain or side chain; and
the aromatic diamine is selected from the group consisting of m-phenylenediamine, 4,4′-diaminodiphenyl ether, p-phenylenediamine, 1,3-bis(3-aminophenoxy)benzene, 1,3-bis(4-aminophenoxy)benzene, and 1,4-bis(4-aminophenoxy)benzene.

9. The resin composition of claim 8, wherein X₃ is an alkyl or alkoxy containing 5-30 carbon atoms.

10. The resin composition of claim 8, wherein the primary amine-capped flexible polyimide oligomer is prepared through steps of:
(S1) dissolving the flexible diamine in a solvent under the protection of nitrogen to obtain a first mixture;
(S2) stepwise adding the tetracarboxylic acid dianhydride to the first mixture; performing reaction at a first preset temperature for a first preset time to obtain a second mixture; and
(S3) adding a catalyst or a water-carrying agent to the second mixture followed by reaction at a second preset temperature for a second preset time and precipitation or drying to obtain the primary amine-capped flexible polyimide oligomer.

11. The resin composition of claim 1, wherein the aldehyde is formaldehyde, paraformaldehyde or a mixture thereof.

12. The resin composition of claim 1, wherein the monofunctional phenolic compound is selected from the group consisting of phenol, methyl phenol, and ethyl phenol.

13. The resin composition of claim 1, wherein the epoxy resin is selected from the group consisting of phenolic epoxy resin, bisphenol A epoxy resin, bisphenol F epoxy resin, bisphenol S epoxy resin, alicyclic epoxy resin, silane modified epoxy resin, vinyl dioxide epoxy resin, epoxidized polybutadiene epoxy resin, trifunctional epoxy resin, and tetraglycidyl epoxy resin.

14. The resin composition of claim 1, wherein the maleimide resin is selected from the group consisting of m-phenylene bismaleimide resin, 4,4-diphenylmethane bismaleimide resin, 4,4-diphenyl ether bismaleimide resin and N,N′-m-phenylene bismaleimide resin.

15. The resin composition of claim 1, wherein the cyanate ester resin is selected from the group consisting of bisphenol A cyanate ester resin, bisphenol E cyanate ester resin, bisphenol F cyanate ester resin, bisphenol M cyanate ester resin, tetramethyl bisphenol A cyanate ester resin and dicyclopentadienyl cyanate ester resin.

16. An adhesive, comprising:
the resin composition of claim 1;
a curing accelerator; and
an organic solvent.

17. The adhesive of claim 16, wherein the curing accelerator is selected from the group consisting of imidazole, 1-methylimidazole, 1,2-dimethylimidazole, formic acid, acetic acid, propionic acid, aniline, benzylamine, azobisisobutyronitrile, azobisisoheptonitrile, benzoyl peroxide, methyl ethyl ketone peroxide, tert-butyl peroxide and a combination thereof.

18. The adhesive of claim 16, wherein the organic solvent is selected from the group consisting of toluene, xylene, dioxane, tetrahydrofuran, methanol, ethanol, acetone, butanone, cyclohexanone, N,N-dimethylformamide, N,N-dimethylacetamide, N-methylpyrrolidone and a combination thereof.

19. The adhesive of claim 16, wherein the adhesive is applied to film adhesive materials, adhesive layers, adhesive sheets, resin-coated copper foils, copper-clad laminates and multi-layer resin substrates.
